(19) United States
(12) Patent Application Publication
(10) Pub. No.: US 2026/0326372 A1
(43) Pub. Date: Oct. 22, 2026

(54) AN ADDITIVE MANUFACTURING APPARATUS FOR ADDITIVELY MANUFACTURING A THREE-DIMENSIONAL OBJECT BY CURING A PHOTOCURABLE RESIN

(71) Applicant: AXTRA3D Inc., Dover, DE (US)

(72) Inventors: GIANNI ZITELLI, Vicenza (IT); FEDERICO IACOVELLA, Vicenza (IT)

(73) Assignee: AXTRA3D Inc., Dover, DE (US)

(21) Appl. No.: 19/109,800

(22) PCT Filed: Nov. 4, 2022
(86) PCT No.: PCT/EP2022/080792

§ 371 Date: Mar. 7, 2025

(51) Int. Cl. B29C 64/245; B29C 64/124; B29C 64/227; B29C 64/25; B29C 64/386; B33Y 10/00; B33Y 30/00; B33Y 50/00

(52) U.S. Cl. CPC B29C 64/245; B29C 64/124; B29C 64/227; B29C 64/25; B29C 64/386; B33Y 10/00; B33Y 30/00; B33Y 50/00

(57) ABSTRACT

An additive manufacturing apparatus for additively manufacturing a three-dimensional object by curing a photocurable resin, particularly of a bottom-up configuration.

The invention relates to an additive manufacturing apparatus for additively manufacturing a three-dimensional object by curing a photocurable resin.

Respective additive manufacturing apparatuses are generally known from the prior art and are configured for additively manufacturing a three-dimensional object by (photo)curing a photocurable resin. The base configuration of respective apparatuses typically, comprises a vat device delimiting a receiving volume for receiving a photocurable resin, a build platform device, the build platform device comprising a build platform, e.g. arranged above the membrane, and moveably supported relative to the membrane in at least one degree of freedom of motion, and an irradiation device, e.g. a digital light projector device, disposed above or below the membrane, the at least one irradiation device configured to emit electromagnetic radiation to selectively and successively cure the photocurable resin provided in the receiving volume to additively manufacture a three-dimensional object in a build direction. The basic operation of respective apparatuses is well-known and needs no further explanation.

While respective apparatuses have been continuously improved and provide satisfactory quality of the printed three-dimensional objects, there still remain process-related challenges which might affect the quality of the manufacturing process and/or the quality of the resulting three-dimensional objects. This particularly applies to the so-called suction (cup) effect which can occur between the bottom wall of the vat device and a cured resin layer when the build platform moves relative to the vat device, e.g. in upward direction.

Hence, there exists a need for a further improved additive manufacturing apparatus for additively manufacturing a three-dimensional object by (photo)curing a photocurable resin.

It is therefore, an object of the present invention to provide an improved additive manufacturing apparatus for additively manufacturing a three-dimensional object by (photo)curing a photocurable resin.

The object is particularly achieved by the subject-matter of the appended Claims.

A first aspect of the invention relates to an additive manufacturing apparatus (“apparatus”) for additively manufacturing a three-dimensional object by (photo)curing a photocurable resin. The apparatus is thus, generally configured to additively manufacture a three-dimensional object by (photo)curing a photocurable resin. Curing a photocurable resin typically, comprises a successive layerwise selective irradiation of the photocurable resin with electromagnetic energy (light) emitted form at least one irradiation device to successively generate cured resin layers of the three-dimensional object to be additively manufactured, wherein each cured resin layer represents a cross-section of the three-dimensional object to be additively manufactured.

The apparatus comprises a vat device. The vat device delimits a receiving volume for receiving a photocurable resin. A respective photocurable resin can be a polyamide resin, for instance. The vat device can comprise one or more vat device elements. One or more vat device elements form one or more walls of the vat device which are arranged and/or oriented to delimit the receiving volume for receiving the photocurable resin. The bottom of the receiving volume is defined by a membrane. As will be apparent from further below, the membrane is typically, attachable or attached to one or more vat device elements of the vat device. The membrane is typically, transmissive to electromagnetic radiation (light) emitted from at least one irradiation device of the apparatus. The membrane thus, has transmissive properties at least with respect to the electromagnetic radiation emitted from the at least one irradiation device of the apparatus. The membrane can thus, be transparent (at least with respect to the properties, e.g. wavelength, of the electromagnetic radiation emitted by the at least one irradiation device of the apparatus). The membrane typically, has a plane base shape. The membrane is typically, elastic and/or flexible. The membrane can thus, exhibit a reversible deflection and/or deformation behavior upon exertion of forces, such as pressure forces, created during operation of the apparatus. Respective forces can directly or indirectly result from a motion of a build platform of the apparatus relative to the membrane, particularly towards the membrane. The membrane can thus, be reversibly deflected and/or deformed with respect to a zero state upon exertion of respective forces. Hence, the membrane can be built of an elastic and/or flexible material or of an elastic and/or flexible material structure enabling the respective reversible deflection and/or deformation behavior. As will be apparent from further below, a respective elastic and/or flexible material can be a polymer material and a respective elastic and/or flexible material structure can be a polymer material structure, for instance.

The apparatus further comprises a build platform device. The build platform device comprises a build platform. The build platform defines a build surface on which a three-dimensional object can be additively manufactured. The build surface typically, comprises a plane surface facing the membrane. The build platform is moveably supported relative to the membrane in at least one degree of freedom of motion. The at least one degree of freedom of motion is typically, a translatory freedom of motion along a translatory axis. The translatory axis is typically, arranged and oriented, respectively perpendicular relative to a base plane of the membrane (in its non-deflected and non-deformed state). The build platform device can comprise one or more actuators, such as one or more electromotors, configured to effect motions of the build platform relative to the membrane along the translatory axis. The one or more actuators can be particularly, configured to effect reciprocal motions of the build platform along the translatory axis; the build platform can thus, be moved in two directions, e.g. upward and downward, along the translatory axis. The build platform is typically, arranged above the membrane. The apparatus can thus, have a so-called bottom-up configuration. However, at least some of the aspects or features of the apparatus specified in the following could also be implemented in so-called top-down configuration. As such, the apparatus can also have a so-called top-down configuration.

The apparatus typically, comprises a transmissive member arranged below the membrane. The transmissive member is at least transmissive to the electromagnetic radiation (light) emitted from the at least one irradiation device of the apparatus. The transmissive member thus, has transmissive properties at least with respect to the electromagnetic radiation emitted from the at least one irradiation device of the apparatus. The transmissive member can thus, be transparent at least with respect to the electromagnetic radiation emitted from the at least one irradiation device of the apparatus. The transmissive member is typically, rigid. Thus, the transmissive member typically, shows no reversible deflection and/or deformation behavior upon exertion of forces during operation of the apparatus. Hence, the transmissive member can be built of a rigid material or of a rigid material structure enabling no reversible deflection and/or deformation behavior during operation of the apparatus. A respective rigid material can be a glass or polymer material and a respective rigid material structure can be a glass structure or a polymer material structure, for instance. According to a concrete but non-limiting example, the transmissive member can be built of glass, particularly borosilicate glass, which shows both the rigidity and required transmission at least with respect to the electromagnetic radiation emitted from the at least one irradiation device of the apparatus.

The transmissive member typically, has a plate-like geometry. The plate-like geometry of the transmissive member comprises at least one plane top surface. The plane top surface of the transmissive member is typically, parallel to the base plane of the membrane when the membrane is in its non-deflected and non-deformed state.

The transmissive member is typically, moveably supported in a horizontal motion plane. As such, the transmissive member is moveable in at least one operating position and in at least one non-operating position. Both the at least one operating position and the at least one non-operating position are typically, arranged in the horizontal motion plane of the transmissive member. The horizontal motion plane of the transmissive member can be a plane parallel to a (horizontal) base plane of the vat device. Particularly, the horizontal motion plane of the transmissive member can be a plane parallel to a base plane of the membrane (in its non-deflected and non-deformed state) or a plane parallel to the build surface of the build platform, respectively.

In the at least one operating position, the transmissive member is generally arranged above or below the membrane such that it can provide or provides a mechanical support for the membrane, particularly in a deflected and/or deformed state of the membrane. In the at least one operating position, the transmissive member is thus, typically, (vertically) adjacently disposed above or below the membrane such that the space above or below the membrane is at least partially occupied by the transmissive member. In the at least one operating position, the transmissive member is particularly arranged below the membrane such that deflections or deformations, e.g. bends, buckles, curvatures, etc., of the membrane occurring during operation of the apparatus, i.e. particularly deflections or deformations of the membrane directly or indirectly resulting from motions of the build platform towards the membrane and the related generation of pressure on the membrane, can be compensated or at least reduced by the transmissive member. The transmissive member is thus, due to its rigidity, configured to compensate and at least reduce respective deflections or deformations of the membrane occurring during operation of the apparatus. Particularly, any deflections or deformations of the membrane against the transmissive member will result in that the deflections or deformations of the membrane will be compensated for or at least reduced due to the plate-like geometry and rigidity of the transmissive member. Particularly, the mechanical contact between the membrane and the transmissive member will result in that deflected or deformed portions of the membrane will be eliminated or reduced because the deflected or deformed portions of the membrane are pushed against the plane top surface of the transmissive member. More particularly, the plate-like geometry of the transmissive member including a plane top surface will result in that any deflected or deformed portion of the membrane which is, particularly due to a motion of the build platform towards the membrane, pushed against the top surface of the transmissive member, will adapt the plane shape of the top surface of the transmissive member. Hence, in the at least one operating position, the transmissive member can assure a (substantially) plane configuration at least of portions of the membrane which enables creating and maintaining a constant gap between the membrane and the build platform during operation of the apparatus which further enables creating and maintaining a constant resin layer thickness during operation of the apparatus. As such, the transmissive member can be deemed a support member because it provides a mechanical support for the membrane, i.e. particularly respective deflected or deformed portions of the membrane, when the membrane is deflected or deformed during operation of the apparatus.

In the at least one non-operating position, the transmissive member is generally not arranged above or below the membrane such that it cannot provide a mechanical support for the membrane, particularly in a deflected and/or deformed state of the membrane. In the at least one non-operating position, the transmissive member is thus, typically, not (vertically) adjacently disposed above or below the membrane such that the space above or below the membrane is not occupied by the transmissive member. In the at least one non-operating position, the transmissive member is thus, particularly not arranged below the membrane such that deflections or deformations of the membrane occurring during operation of the apparatus, i.e. particularly deflections or deformations of the membrane directly or indirectly resulting from motions of the build platform towards the membrane, cannot be compensated or at least reduced by the transmissive member.

Moving the transmissive member from the at least one operating position into the at least one non-operating position is also an effective way to eliminate or at least reduce the suction (cup) effect between a (previously) cured resin layer and the membrane and transmissive member, respectively. This means that, after the transmissive member has been moved into the at least one non-operating position after curing a resin layer, the build platform with the respective cured resin layer attached thereto can be moved away from the membrane (substantially) without or with only little mechanical load exerted on the cured resin layer which would have been the case when the suction (cup) effect would not have been eliminated or reduced.

Motions of the transmissive member between the at least one operating position and the at least one non-operating position can be effected via one or more actuators, such as e.g. one or more electromotors, configured to effect motions of the transmissive member relative to the membrane in the horizontal motion plane. The one or more actuators can be particularly, configured to effect reciprocal motions of the transmissive member in the horizontal motion plane; the transmissive member can thus, be moved in two directions in the horizontal motion plane. As will be apparent from further below, a motion of the transmissive member in the horizontal plane can be or comprise a translatory motion along a translatory axis or a rotary motion about a rotary axis.

The apparatus further comprises at least one irradiation device, such as e.g. a digital light projector device, disposed above or below the transmissive member. The at least one irradiation device is configured to emit electromagnetic radiation to selectively and successively cure the or a photocurable resin received in the receiving volume of the vat device to additively manufacture a three-dimensional object. In exemplary embodiments, the apparatus can comprise at least two different irradiation devices. In an exemplary configuration of the apparatus with at least two different irradiation devices, a first irradiation device can be a digital light projector device and a second irradiation device can be or comprise a laser device. The at least two different irradiation sources can be configured to emit electromagnetic radiation of (substantially) the same wavelength or of similar wavelength. Similar wavelength can mean that the wavelength of the respective electromagnetic radiation differs no more than 10%, particularly no more than 5%, from each other. The apparatus can comprise one or more optical devices assigned to the one or more irradiation devices. Respective optical devices can be arranged in the optical path between the one or more irradiation devices and the membrane. Respective optical devices can comprise at least one of: a beam combining device, a collimating device, an expanding device, a focusing device, a polarizing device, a beam splitting device, etc.

The configuration of the apparatus enables a significant improvement over existing apparatuses particularly, due to the possibility of effectively eliminating or at least significantly reducing the suction (cup) effect which facilitates an improved quality of the additive build process and the resulting three-dimensional objects, respectively.

As indicated above, the membrane generally has a plane base shape in the non-deflected and non-deformed state, respectively. The non-deflected and non-deformed state of the membrane can be deemed or denoted “zero-state”. In the zero-state of the membrane, a gap space can be present between the membrane, i.e. particularly a surface of the membrane facing the transmissive member in the at least one operating position, and the transmissive member, i.e. particularly the top surface of the transmissive member facing the membrane in the at least one operating position. Hence, in the zero-state of the membrane, there is no mechanical contact between the membrane and the transmissive member. As such, motions of the transmissive member from the at least one non-operating position into the at least one operating position cannot be negatively affected by any mechanical contact and related friction-and/or sticking-effects between the transmissive member and the membrane. This means that the base plane of the membrane (in the zero state) and the horizontal motion plane of the transmissive member can be (vertically) offset relative to each other. The gap space between the membrane (in the zero-state) and the transmissive member can be in a range between 25 and 200 μm, particularly in a range between 25 and 175 μm, more particularly in range between 25 and 150 μm, more particularly in a range between 25 and 125 μm, more particularly in a range between 25 and 100 μm, more particularly in a range between 25 and 75 um, more particularly in a range between 25 and 50 μm, for instance. Preferably, the gap space between the membrane (in the zero-state) and the transmissive member can correspond to a layer thickness implemented in an additive manufacturing process when operating the apparatus. The layer thickness can be selected on basis of the properties of the photocurable resin, for instance. An exemplary layer thickness can be in one of the aforementioned ranges.

The at least one degree of freedom of motion of the transmissive member can be a translatory motion of the transmissive member along a horizontal translatory axis, particularly a horizontal translatory axis parallel to the base plane of the membrane. As such, the transmissive member can be moved into the at least one operating position and/or into the at least one non-operating position via a translatory motion within the horizontal motion plane. A translatory motion can be beneficial to achieve certain space requirements necessary for implementing a respective moveable support of the transmissive member, for instance. Alternatively or additionally, the at least one degree of freedom of motion of the transmissive member can be a rotary motion of the transmissive member about a vertical rotary axis, particularly a rotary axis perpendicular to the base plane of the membrane. As such, the transmissive member can be moved into the at least one operating position and/or into the at least one non-operating position via a rotary motion within the horizontal motion plane. Also a rotary motion can be beneficial to achieve certain space requirements necessary for implementing a respective moveable support of the transmissive member. In either case, the apparatus may comprise one or more guide elements enabling a guided motion of the transmissive member along the horizontal motion axis or about the vertical motion axis, respectively.

The apparatus can further comprise at least one actuator device coupleable or coupled with the transmissive member so as to exert a drive force on the transmissive member for moving the transmissive member from the at least one operating position into the at least one non-operating position and vice versa. A respective actuator device can comprise one or more actuators as mentioned above. Respective actuators can generally be or comprise electric actuators, mechanical actuators, electro-mechanical actuators, hydraulic actuators, pneumatic actuators, etc.

The apparatus can further comprise a hardware-and/or software-embodied controller at least configured to control motion of the transmissive member between the operating position and the non-operating position, and vice versa. The controller can communicate at least with the at least one actuator device for generating control signals to control operation of the at least one actuator device to move the transmissive member into the at least one operating position and into the at least one non-operating position, respectively. The controller may be connected with one or more other control devices of the apparatus, such as e.g. a control device for controlling motions of the build platform and/or a control device for controlling the emission of electromagnetic radiation via the at least one irradiation device. Further, the controller can be configured to use information, such as operation information, status information, etc., from the one or more other control devices of the apparatus for generating control signals controlling the motion of the transmissive member between the at least one operating position and the at least one non-operating position and vice versa.

The apparatus can further comprise an adaptive suspension device. The adaptive suspension device is configured to suspense the transmissive member and/or the build platform. Particularly, the adaptive suspension device is configured to adaptively suspense the transmissive member and/or the build platform. Adaptive suspension of the transmissive member and/or the build platform typically, means that the suspension device is configured to move the transmissive member and/or the build platform back to an initial (vertical) position when the transmissive member and/or the build platform has been deflected from the initial (vertical) position, e.g. due to forces being directly or indirectly exerted on the transmissive member due to a motion of the build platform relative to the membrane. A respective initial (vertical) position of the transmissive member and/or the build platform can correspond to a zero-vertical position of the transmissive member and/or the build platform relative to the membrane. In a respective zero-vertical position of the transmissive member and/or the build platform, there can be a gap space between the transmissive member and/or the build platform and the membrane. The gap space can be the gap space as specified further above.

The zero-vertical position of the transmissive member and/or the build platform can be defined by one or more stop elements provided with the apparatus. Respective stop elements can particularly, be provided with a frame structure of the apparatus. A respective stop element can be configured to limit a further upward or downward motion of the transmissive member and/or the build platform beyond the respective zero-vertical position. As an example, a respective stop element can be a mechanical stop element, such as a mechanical engaging element which can comprise a projection, for instance, which, e.g. due to direct or indirect mechanical engagement with the transmissive member, limits a further upward or downward motion of the transmissive member and/or the build platform beyond the zero-vertical position. Likewise, other stop elements such as electric stop elements, magnetic stop elements, etc. are conceivable.

The adaptive suspension device can comprise one or more suspension elements. The one or more suspension elements can be adjustable with respect to a suspension direction of the adaptive suspension device. The suspension direction can correspond to the build direction of the apparatus. The one or more suspension elements can thus, have a variable spatial extension, i.e. particularly a variable longitudinal extension, with respect to the build direction of the apparatus. The one or more suspension elements can thus, be reversibly transferred from a basic state in which they have a first spatial extension into at least one compressed state and/or into at least one extended state in which they have a second spatial extension different from the first spatial extension. Hence, the ability of the one ore more suspension elements of being extended and/or compressed enables that the transmissive member and/or the build platform can be transferred into different vertical positions relative to the membrane.

The one or more suspension elements are typically, configured to automatically return to their basic state which typically, corresponds to the zero-vertical position of the transmissive member and/or the build platform such that also the transmissive member and/or the build platform can be automatically returned to the zero-vertical position. The time required for that the transmissive member and/or the build platform automatically return to the zero-vertical position can be a blank time of the apparatus in which no irradiation occurs. The blank time can depend from diverse parameters, such as viscosity of the photocurable resin, layer thickness, cross-section to be irradiated, and vary accordingly. Hence, the apparatus can enable faster additive manufacturing process because there is no “default blank” time but the apparatus will adaptively adjust the blank time accordingly.

The above-specified effect of compensating or at least reducing respective deflected or deformed portions of the membrane can thus, be improved when the one or more suspension elements return to their basic state and the related motion of a transmissive member suspended by the adaptive suspension device towards the membrane or the build platform, respectively. Particularly, a respective motion of the transmissive member towards the membrane or the build platform, respectively can increase the mechanical contact area between the transmissive member and the membrane resulting in an improved effect of compensating or at least reducing respective deflected or deformed portions of the membrane.

The one or more suspension elements can be built as or comprise a spring element, particularly a compression spring element, for instance. The use of spring elements is a reliable and cost-effective way to implement respective suspension elements. However, other active or passive suspension elements, such as hydraulic cylinders, pneumatic cylinders, piezo elements, etc., are generally conceivable as well.

The adaptive suspension device can comprise a frame structure. The one or more suspension elements can be attached to the frame structure of the adaptive suspension device. The frame structure of the adaptive suspension device can comprise one or more frame structure elements each providing at least one attachment site for a respective suspension element. Particularly, the frame structure can comprise at least one upper frame structure element and at least one lower frame structure element and the one or more suspension elements can be disposed between the at least one upper frame structure element and the at least one lower frame structure element. The at least one upper frame structure element and the at least one lower frame structure element can thus, be connected via the one or more suspension elements.

Also, the transmissive member or the build platform can be attached to the frame structure of the adaptive suspension device via one or more attachment sites. The frame structure can therefore, comprise a receiving portion for receiving the transmissive member or the build platform. The dimensions and/or shape of the receiving portion can correspond to the dimensions and/or shape of the transmissive member or the build platform. As a concrete but non-limiting example, the receiving portion can be provided as a recess within the frame structure or at least one frame structure element, respectively. The dimensions and/or shape of the recess can correspond to the dimensions and/or shape of the transmissive member and/or the build platform to be received therein. Further, one or more attachment elements enabling a stable attachment of the transmissive member or the build platform with the frame structure or the at least one frame structure element can be provided. Respective attachment elements can comprise mechanical attachment elements, such as bolt elements, clamping elements, rivet elements, etc., for instance. Respective attachment elements can also comprise other chemical and/or physical attachment elements, such as adhesives, solders, welds, etc.

The adaptive suspension device can be moveably supported relative to the membrane in at least one degree of freedom of motion in the or a horizontal motion plane so as to be moveable into at least one first position in which the transmissive member suspended by the adaptive suspension device is in the at least one operating position and into at least one second position in which the transmissive member suspended by the adaptive suspension device is in the at least one non-operating position. As such, motions of the transmissive member in the at least one operating position and/or in the at least one non-operating position can be effected via motions of the adaptive suspension device in the first position and the second position, respectively. As such, the adaptive suspension device can be provided with one or more actuators effecting motions of the adaptive suspension device in the at least one degree of freedom of motion.

The apparatus can further comprise a sensor device configured to determine the lateral and/or a horizontal position of the transmissive member and/or the build platform, particularly relative to the membrane. The sensor device can be particularly, configured to generate sensor information indicative of a position of the transmissive member and/or the build platform. A respective sensor information can directly or indirectly indicate a position of the transmissive member and/or the build platform which corresponds to a respective zero-vertical position. The sensor device can thus, be configured to determine if the transmissive member and/or the build platform is in the zero-vertical position and/or if the transmissive member and/or the build platform is not in the zero-vertical position. Alternatively or additionally, a respective sensor information can directly or indirectly indicate a position of the transmissive member which corresponds to the at least one operating position and/or to the at least one non-operating position. The sensor device can thus, be configured to determine if the transmissive member is in the at least one operating position and/or in the at least one non-operating position or if the transmissive member is not in the at least one operating position and/or not in the at least one non-operating position, for instance.

A respective sensor device can comprise one or more sensor elements. Respective sensor elements can comprise at least one of: acoustic sensor elements, electro-mechanic sensor elements, magnetic sensor elements, electro-magnetic sensor elements, optic sensor elements, for instance. Respective sensor elements can be provided with the frame structure of the adaptive suspension device and/or adjacent to the frame structure of the adaptive suspension device, for instance. Respective sensor elements can be arranged in one or more planes, particularly in one or more horizontal and/or vertical planes. Respective sensor elements can particularly, be arranged to form a sensor element array, e.g. to improve the (total) detection area of the sensor device.

Returning to the configuration of vat device, the following exemplary configuration is conceivable: the vat device can comprise multiple frame-like vat device elements connectable or connected with each other to build the vat device. Respective frame-like vat device elements can form respective vat device elements mentioned above. Particularly, the vat device can comprise a first frame-like vat device element and a second frame-like vat device element. The first frame-like vat device element can comprise at least one first connection interface and the second frame-like vat device element can comprise at least one second connection interface, wherein the at least one first connection interface and the at least one second connection interface are configured to co-act to clamp the membrane between the first frame-like vat device element and the second frame-like vat device element. The first connection interface and the second connection interface can be built as engagement elements, for instance. Particularly, the first connection interface, which can be built as or comprises a receiving portion, can be configured to receive the second connection element, which can be a protrusion which is configured to engage the receiving portion. Also, an inverse configuration is conceivable as well. Further, bolted connections can be provided alternatively or additionally As such, a highly stable attachment of the membrane with the vat device is possible which positively affects the quality of the manufacturing process and the three-dimensional objects resulting therefrom.

At least one of the first frame-like vat device element and the second frame-like vat device element can comprise or form a deformation compensation section which is configured to compensate for deformation effects of the membrane due to clamping the membrane between the at least one first frame-like vat device element and the second frame-like vat device element which could or would result in an uneven shape of the membrane and consequently, in an uneven bottom of the receiving volume of the vat device. The generally plane base shape of the membrane can thus, be assured at least when no forces are exerted to the membrane resulting from motions of the build platform towards the membrane. As such, the aforementioned zero-state of the membrane can be implemented.

The deformation compensation section of the first or second frame-like vat device element can comprise at least a first, a second and a third sub-section. The at least three sub-sections can form separate portions of a monolithic first or second frame-like vat device element. The second sub-section can be arranged or formed between the first sub-section and the third sub-section and connecting same. The first sub-section can extend inclined relative to the membrane, the third sub-section can extend parallel to the membrane, and the second sub-section can extend with a curvature. As such, a so-called Poisson compensation profile can be built.

The membrane can comprise multiple membrane elements connectable or connected with each other to build the membrane. The membrane elements forming the membrane are typically, arranged in a vertically stacked arrangement, i.e. the membrane elements can be provided as stacked membrane layers. Forming the membrane from multiple membrane elements or membrane layers can provide advantages e.g. with respect to a desired non-sticking behavior of the membrane relative to different materials, such as a (cured) photocurable resin and a material forming the transmissive member, for instance.

The multiple membrane elements or membrane layers can be bonded with each other by means of at least one bonding agent, e.g. an adhesive and/or cohesive bonding agent, for instance. Generally, bonding of at least two respective stacked membrane elements or membrane layers can be provided or supported by bonding agents, such as adhesive agents, for instance. Alternatively or additionally, mechanical bonding of the of at least two respective stacked membrane elements or membrane layers, e.g. via a force-and/or press-fit, is conceivable.

The membrane can comprise a first membrane element or membrane layer which comprises an anti-sticking surface or an anti-sticking material which exhibits an anti-sticking effect relative to the or a photocurable resin, particularly relative to a resin layer formed by curing the photocurable resin, and a second membrane element or membrane layer which comprises an anti-sticking surface or an anti-sticking material which exhibits an anti-sticking effect relative to the transmissive member, particularly relative to the top surface of the transmissive member. Respective anti-sticking effects enable that a resin layer formed by curing the photocurable resin can be easily removed from the membrane and that the transmissive member can be easily moved relative to the membrane, e.g. from the at least one operating position into the at least one non-operating position, even when there is a mechanical contact between the transmissive member and the membrane. In other words, friction effects due a movement of the transmissive member relative to the membrane can be significantly reduced.

Hence, the first membrane element or layer can generally be built of any anti-sticking or anti-friction material or material structure which reduces sticking or friction effects between the first membrane element and a resin layer formed by curing the photocurable resin. As an example, the first membrane element or membrane layer can be made from or comprise at least one fluoropolymer, particularly (poly)tetrafluoroethylene or a (poly)tetrafluoroethylene compound, for instance. Likewise, the first membrane element or membrane layer can be made from or comprise one or more (viscous) lubricant materials, such as or comprising silicone. Respective lubricant materials can comprise one or more anti-sticking or anti-friction materials.

Further, the second membrane element or membrane layer can generally be built of any anti-sticking or anti-friction material or material structure which reduces sticking or friction effects between the second membrane element and the transmissive member. As an example, the second membrane element or membrane layer can be made from or comprise at least one polyester-based polymer, particularly poly(ethylene terephthalate) or a poly(ethylene terephthalate) compound. Likewise, the second membrane element or membrane layer can be made from or comprise one or more (viscous) lubricant materials, such as or comprising silicone. Respective lubricant materials can comprise one or more anti-sticking or anti-friction materials.

In either case, the respective membrane element which faces the build platform can be used as the so-called zero-reference during the manufacturing process.

Additionally or alternatively, the transmissive member could be provided, particularly at its top surface, with a respective anti-sticking surface or anti-sticking material which provides an anti-sticking effect relative to the membrane, particularly the lower surface of the membrane which faces the transmissive member in its operating position. Likewise, the transmissive member can at least partly be coated with one or more (viscous) lubricant materials, such as or comprising silicone. Respective lubricant materials can comprise one or more anti-sticking or anti-friction materials.

A second aspect of the invention relates to a method for additively manufacturing a three-dimensional object by selectively and successively curing a photocurable resin provided in a receiving volume of a vat device via electromagnetic radiation emitted from at least one irradiation device. The method is implemented by an additive manufacturing apparatus, particularly an additive manufacturing apparatus according to the first aspect of the invention.

The method comprises at least one step of: moving a transmissive member in a horizontal motion plane in at least one operating position in which it provides a mechanical support for the membrane of the vat device of the additive manufacturing apparatus, and/or moving the or a transmissive member in the or a horizontal motion plane in at least one non-operating position in which it does not provide a mechanical support for the membrane of the vat device of the additive manufacturing apparatus.

All annotations regarding the apparatus of the first aspect of the invention also apply to the method according to the second aspect of the invention and vice versa.

When implemented with an additive manufacturing apparatus comprising a bottom-up configuration, the method can particularly, comprise the steps of: (i) moving a build platform downward towards the membrane of the vat device of the additive manufacturing apparatus thereby exerting a force acting on the membrane which results in a temporary deflection or deformation of the membrane relative to a zero-state of the membrane; (ii) due to the deflection or deformation of the membrane, moving the transmissive member positioned in an operating position below the membrane in a downward direction thereby transferring one or more suspension elements of an adaptive suspension device which suspends the transmissive member from their basic state in a compressed state; (iii) transferring the one or more suspension elements back to their basic state, thereby moving the transmissive member upward in a zero-vertical position; (iv′) optionally, detecting, e.g. via a sensor device, that the transmissive member is in its zero-vertical position; (iv) emitting electromagnetic radiation from the irradiation device to generate a cured resin layer, when the transmissive member has been returned in its zero-vertical position and is arranged in its zero-vertical position; (v) moving the transmissive member in at least one non-operating position, particularly so as to eliminate or reduce the suction effect between the cured resin layer and the transmissive member when moving the build platform having the cured resin layer attached thereto in an upward direction (because the transmissive member is no longer below the cured resin layer in the at least one non-operating position); (vi) moving the build platform upward to create a space for new resin layer between the cured resin layer and the membrane; and (vii) repeating the aforementioned steps (i)-(vi) one or more times until a three-dimensional object of desired configuration is built.

The above-specified effect of compensating or at least reducing respective deflected or deformed portions of the membrane can be improved by a respective upward motion of the transmissive member towards the build platform. Particularly, the upward motion of the transmissive member can increase the mechanical contact area between the transmissive member and the membrane resulting in an improved effect of compensating or at least reducing respective deflected or deformed portions of the membrane.

The above steps (i)-(vii) can also be implemented with an additive manufacturing apparatus having a top-down configuration in analogous manner.

The disclosure will also be readily understood by the following description of exemplary embodiments in conjunction with the accompanying drawings in which:

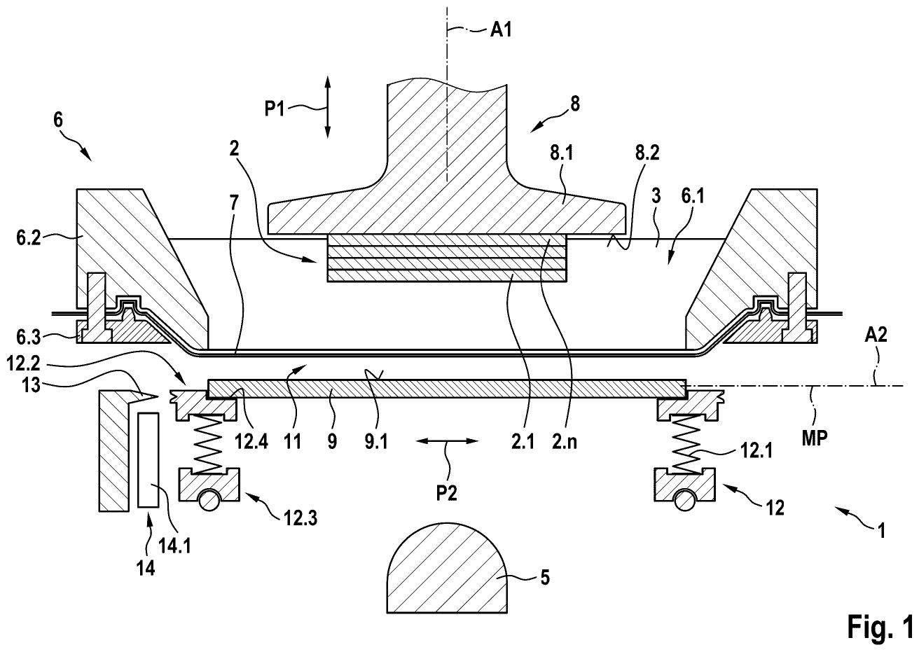

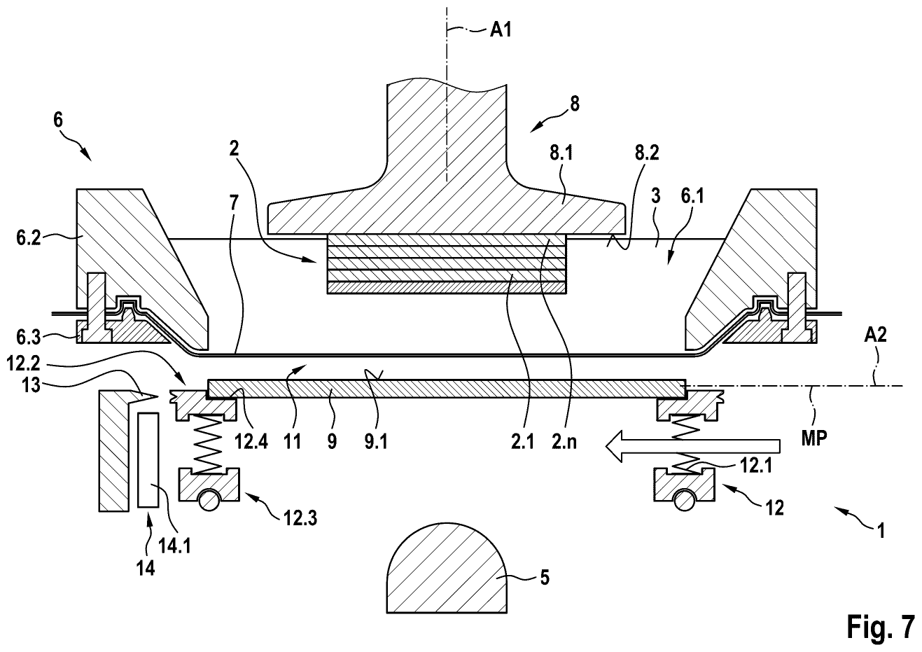

FIG. 1-7 illustrate a principle drawing of an additive manufacturing apparatus in accordance with an exemplary embodiment;

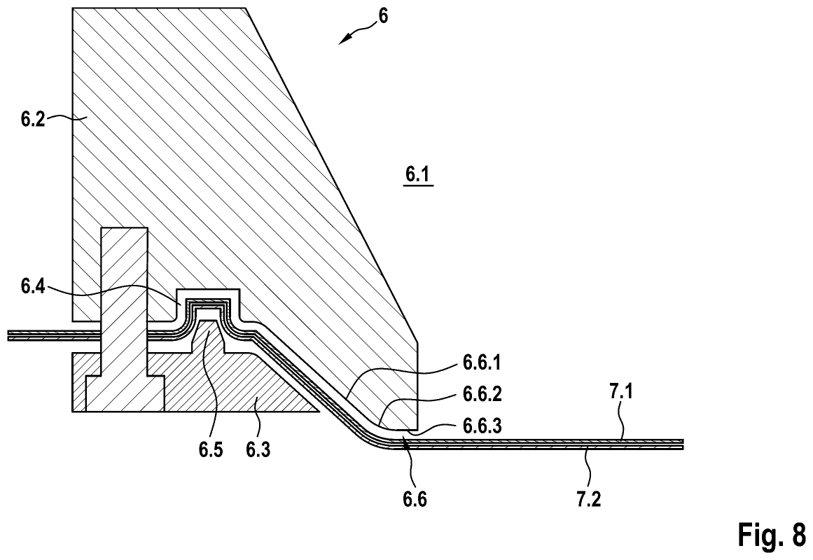

FIG. 8 illustrates an enlarged principle drawing of a vat device and a membrane in accordance with an exemplary embodiment; and

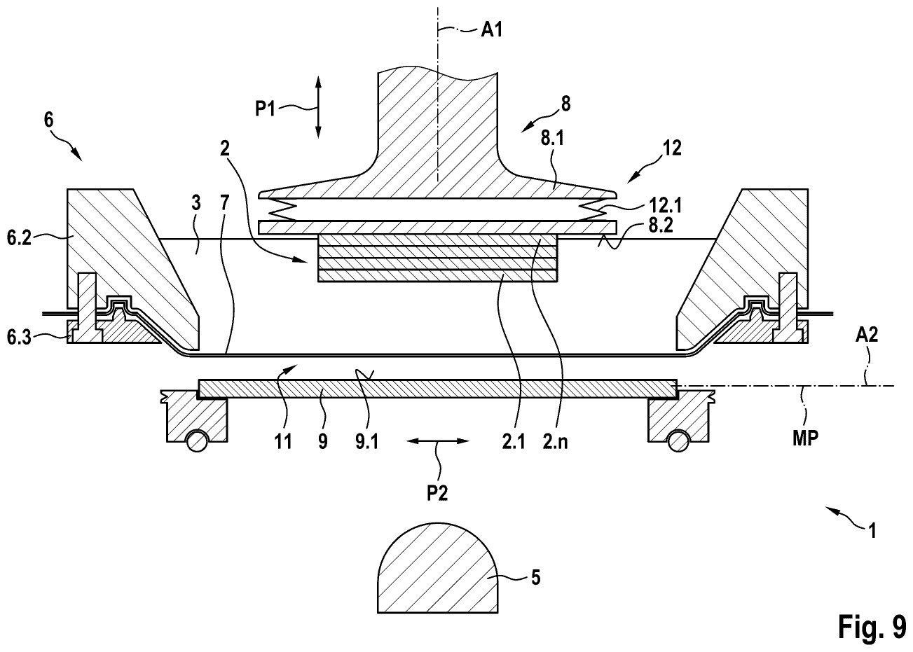

FIG. 9 illustrates a principle drawing of an additive manufacturing apparatus in accordance with another exemplary embodiment.

FIG. 1-7 each illustrate a principle drawing of an additive manufacturing apparatus 1 (“apparatus”) in accordance with an exemplary embodiment.

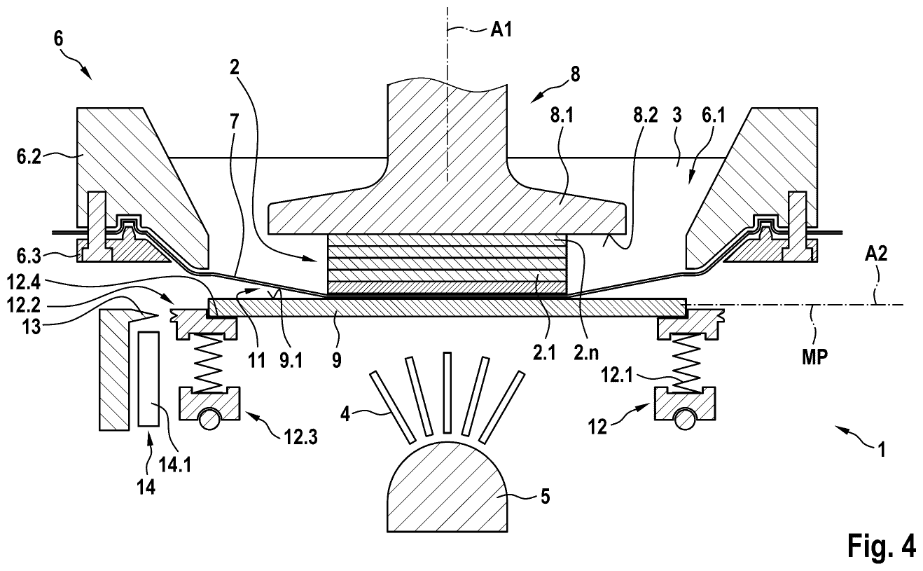

The apparatus 1 is generally configured to additively manufacture a three-dimensional object 2 (the three-dimensional object 2 merely being indicated by cured resin layers 2.1-2.n in the Fig.) by (photo)curing a photocurable resin 3. Curing a photocurable resin 3 via the apparatus 1 typically, comprises a successive layerwise selective irradiation of the photocurable resin 3 with electromagnetic energy 4 (light) (see FIG. 4) emitted form at least one irradiation device 5 to successively generate respective cured resin layers 2.1-2.n of the three-dimensional object 2 to be additively manufactured, wherein each cured resin layer 2.1-2.n represents a cross-section of the three-dimensional object 2 to be additively manufactured.

The apparatus 1 comprises a vat device 6. The vat device 6 delimits a receiving volume 6.1 for receiving the photocurable resin 3. The vat device 6 can comprise one or more vat device elements 6.2, 6.3, wherein at least one vat device element 6.1 forms a wall of the vat device 6 which is arranged and/or oriented to delimit the receiving volume 6.1 for receiving the photocurable resin 3. The bottom of the receiving volume 6.1 is defined by a membrane 7. As is apparent from the Fig., the membrane 7 is typically, attachable or attached to one or more vat device elements 6.2, 6.3 of the vat device 6. The membrane 7 is typically, transmissive to radiation (light) emitted from the irradiation device 5 of the apparatus 1. The membrane 7 thus, has transmissive properties at least with respect to the electromagnetic radiation emitted from the irradiation device 5 of the apparatus 1. The membrane 7 can thus, be transparent (at least with respect to the properties, e.g. wavelength, of the electromagnetic radiation emitted by the at least one irradiation device of the apparatus).

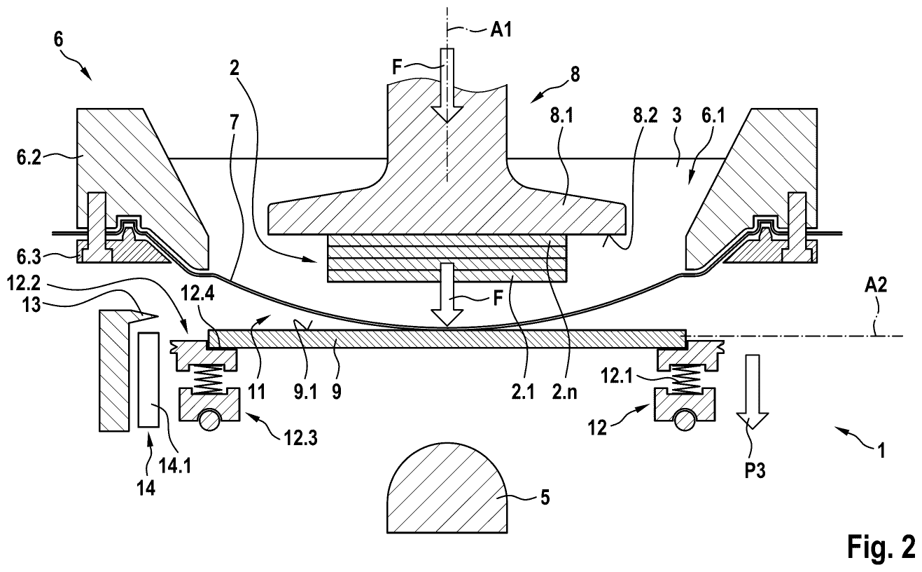

The membrane 7 is typically, elastic and/or flexible and typically, has a plane base shape. The membrane 7 can thus, exhibit a reversible deflection and/or deformation behavior upon exertion of forces (indicated by arrow Fin FIG. 2), such as pressure forces, during operation of the apparatus 1. As is indicated in FIG. 2, respective forces can directly or indirectly result from a motion of a build platform 8.1 of the apparatus 1 relative to the membrane 7. The membrane 7 can thus, be reversibly deflected and/or deformed with respect to a zero state of the membrane 7 (see FIG. 1) upon exertion of respective forces. Hence, the membrane 7 can be built of an elastic and/or flexible material or of an elastic and/or flexible material structure enabling the respective reversible deflection and/or deformation behavior. As will be apparent from further below, a respective elastic and/or flexible material can be a polymer material and a respective elastic and/or flexible material structure can be a polymer material structure, for instance.

As indicated above, the apparatus 1 further comprises a build platform device 8 which comprises the build platform 8.1. The build platform 8.1 defines a build surface 8.2 on which a three-dimensional object 2 can be additively manufactured. The build surface 8.2 typically, comprises a plane surface facing the membrane 7. As is indicated by double-arrow P1 in FIG. 1, the build platform 8.1 is moveably supported relative to the membrane 7 in at least one degree of freedom of motion. In the exemplary embodiments of the Fig., the at least one degree of freedom of motion is a translatory freedom of motion along a translatory axis A1. The translatory axis Al is arranged and oriented, respectively perpendicular relative to the base plane of the membrane 7 (in its non-deflected and non-deformed state). The build platform device 8 can comprise one or more actuators (not shown), such as one or more electromotors, configured to effect motions of the build platform 8.1 relative to the membrane 7 along the translatory axis A1. The one or more actuators can be particularly, configured to effect reciprocal motions of the build platform 8.1 along the translatory axis A1; the build platform 8.1 can thus, be moved in two directions, e.g. upward and downward, along the translatory axis A1.

In the exemplary embodiments of the Fig., the build platform 8.1 is arranged above the membrane 7. The apparatus 1 thus, has a so-called bottom-up configuration with the build platform 8.1 being arranged above the membrane 7 and the irradiation device 5 being arranged below the membrane 7. However, the apparatus 1 could also generally have a so-called top-down configuration.

The apparatus 1 further comprises a transmissive member 9 arranged below the membrane 7. The transmissive member 9 is at least transmissive to the electromagnetic radiation (light) emitted from the irradiation device 5 of the apparatus 1. The transmissive member 9 thus, has transmissive properties at least with respect to the electromagnetic radiation emitted from the irradiation device 5 of the apparatus 1. The transmissive member 9 is thus, transparent at least with respect to the electromagnetic radiation emitted from the irradiation device 5 of the apparatus 1. The transmissive member 9 is (substantially) rigid. Thus, the transmissive member 9 typically, shows no reversible deflection and/or deformation behavior upon exertion of forces F during operation of the apparatus 1. Hence, the transmissive member 9 can be built of a rigid material or of a rigid material structure enabling no reversible deflection and/or deformation behavior during operation of the apparatus 1. A respective rigid material can be a glass or polymer material and a respective rigid material structure can be a glass structure or a polymer material structure, for instance. According to a concrete but non-limiting example, the transmissive member 9 can be built of glass, particularly borosilicate glass, which shows both the rigidity and required transmission at least with respect to the electromagnetic radiation emitted from the irradiation device 5 of the apparatus 1.

In the exemplary embodiments of the Fig, the transmissive member 9 has a plate-like geometry. The plate-like geometry of the transmissive member 9 comprises a plane top surface 9.1. The plane top surface 9.1 of the transmissive member 9 is typically, parallel to the base plane of the membrane 7 when the membrane 7 is in its non-deflected and non-deformed state as is exemplarily illustrated in FIG. 1.

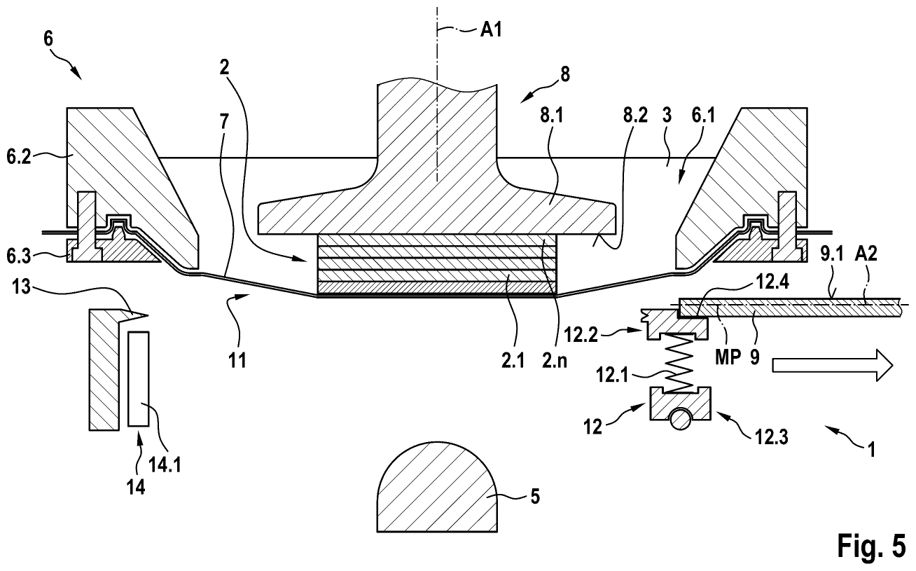

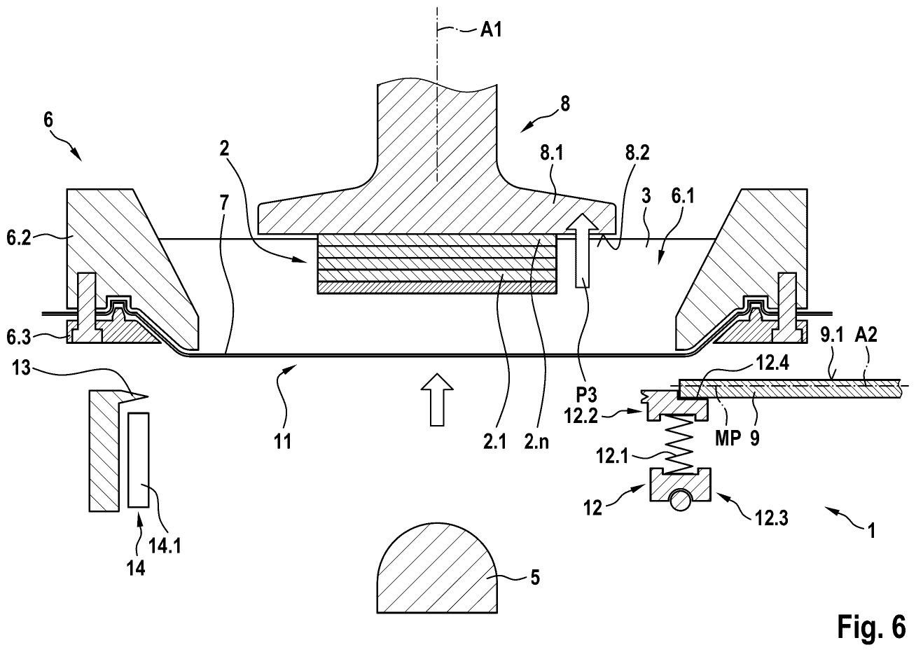

As is indicated by double-arrow P2 in FIG. 1, the transmissive member 9 is moveably supported in a horizontal motion plane MP. As such, the transmissive member 9 is moveable in an operating position (as shown in FIG. 1-4 and FIG. 7) and in a non-operating position (as shown in FIGS. 5 and 6). Both the operating position and the non-operating position are typically, arranged in the horizontal motion plane MP. The horizontal motion plane MP can be a plane parallel to a (horizontal) base plane of the vat device 6. Particularly, the horizontal motion plane MP can be a plane parallel to a base plane of the membrane 7 (in its non-deflected and non-deformed state) or a plane parallel to the build surface 8.2 of the build platform 8.1, respectively.

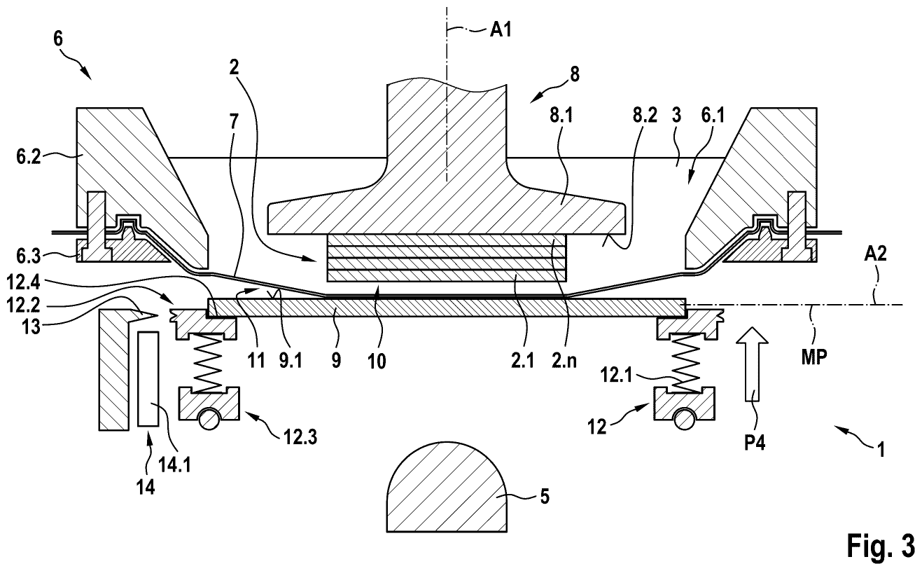

As shown in FIG. 1-4 and FIG. 7, the transmissive member 9 is generally arranged below the membrane 7 in the operating position such that it can provide or provides a mechanical support for the membrane 7, particularly in a deflected and/or deformed state of the membrane 7 (see FIGS. 2, 3). In the operating position, the transmissive member 9 is thus, vertically adjacently disposed below the membrane 7 such that the space below the membrane 7 is at least partially occupied by the transmissive member 9. In the operating position, the transmissive member 9 is particularly arranged below the membrane 7 such that deflections or deformations, e.g. bends, buckles, curvatures, etc., of the membrane 7 (as shown in FIG. 2) occurring during operation of the apparatus 1, i.e. particularly deflections or deformations of the membrane 7 directly or indirectly resulting from motions of the build platform 8.1 towards the membrane 7 and the related generation of pressure on the membrane 7, can be compensated or at least reduced by the transmissive member 9. The transmissive member 9 is thus, due to its rigidity, configured to compensate and at least reduce respective deflections or deformations of the membrane 7 occurring during operation of the apparatus 1. Particularly, any deflections or deformations of the membrane 7 against the transmissive member 9 will result in that the deflections or deformations of the membrane 7 will be compensated for or at least reduced due to the plate-like geometry and rigidity of the transmissive member 9. Particularly, the mechanical contact between the membrane 7 and the transmissive member 9 will result in that deflected or deformed portions of the membrane 7 will be eliminated or reduced because the deflected or deformed portions of the membrane 7 are pushed against the plane top surface 9.1 of the transmissive member 9 (as is indicated from FIGS. 2, 3). More particularly, the plate-like geometry of the transmissive member 9 including the plane top surface 9.1 will result in that any deflected or deformed portion of the membrane 7 which is, particularly due to a motion of the build platform 8.1 towards the membrane 7, pushed against the top surface 9.1 of the transmissive member 9, will adapt the plane shape of the top surface 9.1 of the transmissive member 9. Hence, in the operating position, the transmissive member 9 can assure a (substantially) plane configuration at least of portions of the membrane 7 which enables creating and maintaining a constant gap 10 between the membrane 7 and the build platform 8.1 during operation of the apparatus 1 which further enables creating and maintaining a constant resin layer thickness during operation of the apparatus 1. As such, the transmissive member 9 can be deemed a support member because it provides a mechanical support for the membrane 7, i.e. particularly respective deflected or deformed portions of the membrane 7, when the membrane 7 is deflected or deformed during operation of the apparatus 1.

In the at least one non-operating position as shown in FIGS. 5, 6, the transmissive member 9 is generally not arranged below the membrane 7 such that it cannot provide a mechanical support for the membrane 7, particularly in a deflected and/or deformed state of the membrane 7. In the non-operating position, the transmissive member 9 is thus, typically, not vertically adjacently disposed below the membrane 7 such that the space below the membrane 7 is not occupied by the transmissive member 9. In the non-operating position, the transmissive member 9 is thus, particularly not arranged below the membrane 7 such that deflections or deformations of the membrane 7 occurring during operation of the apparatus 1, i.e. particularly deflections or deformations of the membrane 7 directly or indirectly resulting from motions of the build platform 8.1 towards the membrane 7, cannot be compensated or at least reduced by the transmissive member 9.

Moving the transmissive member 9 from the operating position into the non-operating position is also an effective way to eliminate or at least reduce the suction (cup) effect between a previously cured resin layer 2.1 and the membrane 7 and transmissive member 9, respectively. This means that, after the transmissive member 9 has been moved into the non-operating position after curing a resin layer 2.1 (see FIG. 5), the build platform 8.1 with the respective cured resin layer 2.1 attached thereto can be moved away from the membrane 7 (substantially) without or with only little mechanical load exerted on the cured resin layer 2.1 (as indicated by arrow P3 in FIG. 6) which would have been the case when the suction (cup) effect would not have been eliminated or reduced.

Motions of the transmissive member 9 between the operating position and the non-operating position can be effected via one or more actuators (not shown), such as e.g. one or more electromotors, configured to effect motions of the transmissive member 9 relative to the membrane 7 in the horizontal motion plane MP. The one or more actuators can be particularly, configured to effect reciprocal motions of the transmissive member 9 in the horizontal motion plane MP; the transmissive member 9 can thus, be moved in two directions in the horizontal motion plane MP. As will be apparent from further below, a motion of the transmissive member 9 in the horizontal motion plane MP can be or comprise a translatory motion along a translatory axis A2 or a rotary motion about a rotary axis.

In the exemplary embodiments of the Fig., the at least one degree of freedom of motion of the transmissive member 9 is a translatory motion of the transmissive member along the horizontal translatory axis A2 which is parallel to the base plane of the membrane 7. As such, the transmissive member 9 can be moved into the operating position and/or into the non-operating position via a translatory motion within the horizontal motion plane MP. A translatory motion can be beneficial to achieve certain space requirements necessary for implementing a respective moveable support of the transmissive member 9, for instance.

Alternatively or additionally, the at least one degree of freedom of motion of the transmissive member 9 can be a rotary motion of the transmissive member about a vertical rotary axis (e.g. an axis parallel to axis A1), particularly a rotary axis perpendicular to the base plane of the membrane 7. As such, the transmissive member 9 can be moved into the operating position and/or into the non-operating position via a rotary motion within the horizontal motion plane MP. Also a rotary motion can be beneficial to achieve certain space requirements necessary for implementing a respective moveable support of the transmissive member 9.

In either case, the apparatus 1 may comprise one or more guide elements (not shown) enabling a guided motion of the transmissive member 9 along the horizontal motion axis A2 or about the vertical motion axis, respectively.

The apparatus 1 can further comprise at least one actuator device (not shown) coupleable or coupled with the transmissive member 9 so as to exert a drive force on the transmissive member 9 for moving the transmissive member 9 from the operating position into the non-operating position and vice versa. A respective actuator device can comprise one or more actuators as mentioned above. Respective actuators can generally be or comprise electric actuators, mechanical actuators, electro-mechanical actuators, hydraulic actuators, pneumatic actuators, etc.

The apparatus 1 can further comprise a hardware-and/or software-embodied controller (not shown) at least configured to control motion of the transmissive member 9 between the operating position and the non-operating position, and vice versa. The controller can communicate at least with the at least one actuator device for generating control signals to control operation of the at least one actuator device to move the transmissive member 9 into the operating position and into the non-operating position, respectively. The controller may be connected with one or more other control devices of the apparatus 1, such as e.g. a control device for controlling motions of the build platform 8.1 and/or a control device for controlling the emission of electromagnetic radiation via the irradiation device 5. Further, the controller can be configured to use information, such as operation information, status information, etc., from the one or more other control devices of the apparatus 1 for generating control signals controlling the motion of the transmissive member 9 between the operating position and the non-operating position and vice versa.

As mentioned above, the apparatus 1 further comprises the irradiation device 5, such as e.g. a digital light projector device, which is disposed below the transmissive member 9 in the exemplary embodiments. The irradiation device 5 is configured to emit electromagnetic radiation to selectively and successively cure the or a photocurable resin 43 provided in the receiving volume 6.1 of the vat device 6 to additively manufacture a three-dimensional object 2.

The configuration of the apparatus 1 enables a significant improvement over existing apparatuses particularly, due to the possibility of effectively eliminating or at least significantly reducing the suction (cup) effect which facilitates an improved quality of the additive build process and the resulting three-dimensional objects 2, respectively.

As indicated above, the membrane 7 generally has a plane base shape in the non-deflected and non-deformed state, respectively as shown in FIG. 1. The non-deflected and non-deformed state of the membrane 7 can be deemed or denoted “zero-state”. FIG. 1 further shows that, in the zero-state of the membrane 7, a gap space 11 is present between the membrane 7, i.e. particularly a surface of the membrane 7 facing the transmissive member 9 in the operating position, and the transmissive member 9, i.e. particularly the top surface 9.1 of the transmissive member 9 facing the membrane 7 in the operating position. Hence, in the zero-state of the membrane 7, there is no mechanical contact between the membrane 7 and the transmissive member 9. As such, motions of the transmissive member 9 from the non-operating position into the operating position cannot be negatively affected by any mechanical contact and related friction-and/or sticking-effects between the transmissive member 9 and the membrane 7. This means that the base plane of the membrane 7 (in the zero state) and the horizontal motion plane MP of the transmissive member 9 can be (vertically) offset relative to each other. The gap space 11 between the membrane 7 (in the zero-state) and the transmissive member 9 can be in a range between 25 and 200 μm, particularly in a range between 25 and 175 μm, more particularly in range between 25 and 150 μm, more particularly in a range between 25 and 125 μm, more particularly in a range between 25 and 100 um, more particularly in a range between 25 and 75 μm, more particularly in a range between 25 and 50 μm, for instance. Preferably, the gap space 11 between the membrane 7 (in the zero-state) and the transmissive member 9 can correspond to a layer thickness implemented in an additive manufacturing process when operating the apparatus 1. The layer thickness can be selected on basis of the properties of the photocurable resin, for instance. An exemplary layer thickness can be in one of the aforementioned ranges.

In the exemplary embodiments of the Fig., the apparatus 1 further comprises an adaptive suspension device 12. The adaptive suspension device 12 is configured to adaptively suspense the transmissive member 9. Adaptive suspension of the transmissive member 9 typically, means that the adaptive suspension device 12 is configured to move the transmissive member 9 back to an initial (vertical) position as shown in FIG. 1 when the transmissive member 9 has been deflected from the initial (vertical) position, e.g. due to forces F being directly or indirectly exerted on the transmissive member 9 due to a motion of the build platform 8.1 relative to the membrane 7. FIG. 2 particularly shows a state in which the transmissive member 9 has been deflected from the initial (vertical) position (as indicated by arrow P3), particularly due to hydrostatic pressure on the transmissive member 9, and FIG. 3 shows a state in which the transmissive member 9 has been moved back to initial (vertical) position (as indicated by arrow P4).

A respective initial (vertical) position of the transmissive member 9 can correspond to a zero-vertical position of the transmissive member 9 relative to the membrane 7. FIG. 1 shows that, in a respective zero-vertical position of the transmissive member 9, there exists the gap space 11 between the transmissive member 9 and the membrane 7.

FIG. 1 shows schematically that the zero-vertical position of the transmissive member 9 can be defined by one or more stop elements 13 provided with the apparatus 1. Respective stop elements 13 can particularly, be provided with a frame structure (not shown) of the apparatus 1. A respective stop element 13 can be configured to limit a further upward or downward motion of the transmissive member 9 beyond the respective zero-vertical position. As an example, a respective stop element 13 can be a mechanical stop element, such as a mechanical engaging element which can comprise a projection, for instance, which, e.g. due to direct or indirect mechanical engagement with the transmissive member 9, limits a further upward motion of the transmissive member 9 beyond the zero-vertical position. Likewise, other stop elements such as electric stop elements, magnetic stop elements, etc. are conceivable.

The adaptive suspension device 12 can comprise one or more suspension elements 12.1. The one or more suspension elements 12.1 can be adjustable with respect to a suspension direction of the adaptive suspension device 12. The suspension direction can correspond to the build direction of the apparatus 1. The one or more suspension elements 12.1 can thus, have a variable spatial extension, i.e. particularly a variable longitudinal extension, with respect to the build direction of the apparatus 1. The one or more suspension elements 12.1 can thus, be reversibly transferred from a basic state (as shown in FIG. 1) in which they have a first spatial extension into at least one compressed state (as shown in FIG. 2) in which they have a second spatial extension different from the first spatial extension. Hence, the ability of the one or more suspension elements 12.1 of being compressed enables that the transmissive member 9 can be transferred into different vertical positions relative to the membrane 7.

The one or more suspension elements 12.1 are typically, configured to automatically return to their basic state which typically, corresponds to the zero-vertical position of the transmissive member 9 such that also the transmissive member 9 can be automatically returned to the zero-vertical position. The time required for that the transmissive member 9 to automatically return to the zero-vertical position can be a blank time of the apparatus 1 in which no irradiation occurs. The blank time can depend from diverse parameters, such as viscosity of the photocurable resin, layer thickness, cross-section to be irradiated, and vary accordingly. Hence, the apparatus 1 can enable faster additive manufacturing process because there is no “default blank” time but the apparatus 1 will adaptively adjust the blank time accordingly via the adaptive suspension device 12.

As is shown in the Fig., the one or more suspension elements 12.1 can be built as or comprise spring elements, particularly compression spring elements, for instance. The use of spring elements is a reliable and cost-effective way to implement respective suspension elements. However, other active or passive suspension elements 12.1, such as hydraulic cylinders, pneumatic cylinders, piezo elements, etc., are generally conceivable as well.

As is further shown in the Fig., the adaptive suspension device 12 can comprise a frame structure. The one or more suspension elements 12.1 can be attached to the frame structure. The frame structure can comprise one or more frame structure elements 12.2, 12.3 each providing at least one attachment site for a respective suspension element 12.1. Particularly, the frame structure can comprise at least one upper frame structure element 12.2 and at least one lower frame structure element 12.3 and the one or more suspension elements 12.1 can be disposed between the at least one upper frame structure element 12.2 and the at least one lower frame structure element 12.3. The at least one upper frame structure element 12.2 and the at least one lower frame structure element 12.3 can thus, be connected via the one or more suspension elements 12.1.

As is further shown in the Fig., the transmissive member 9 can be attached to the frame structure of the adaptive suspension device 12 via one or more attachment sites. The frame structure can therefore, comprise a receiving portion 12.4 for receiving the transmissive member 9. The dimensions and/or shape of the receiving portion 12.4 can correspond to the dimensions and/or shape of the transmissive member 9. As a concrete but non-limiting example shown in the Fig., the receiving portion 12.4 can be provided as a recess within the frame structure or at least one frame structure element 12.2, respectively. The dimensions and/or shape of the recess 12.4 can correspond to the dimensions and/or shape of the transmissive member 9 to be received therein. Further, one or more attachment elements (not shown) enabling a stable attachment of the transmissive member 9 with the frame structure or the at least one frame structure element 12.2 can be provided. Respective attachment elements can comprise mechanical attachment elements, such as bolt elements, clamping elements, rivet elements, etc., for instance. Respective attachment elements can also comprise other chemical and/or physical attachment elements, such as adhesives, solders, welds, etc.

As is further shown in the Fig., the adaptive suspension device 12 can be moveably supported relative to the membrane 7 in at least one degree of freedom of motion in the horizontal motion plane MP so as to be moveable into a first position (as shown in FIG. 1-4 and FIG. 7) in which the transmissive member 9 suspended by the adaptive suspension device 12 is in the operating position and into a second position (as shown in FIGS. 5 and 6) in which the transmissive member 9 suspended by the adaptive suspension device 12 is in the non-operating position. As such, motions of the transmissive member 9 in the operating position and/or in the non-operating position can be effected via motions of the adaptive suspension device 12 in the first position and the second position, respectively. As such, the adaptive suspension device 12 can be provided with one or more actuators (not shown) effecting motions of the adaptive suspension device 12 in the at least one degree of freedom of motion.

The apparatus 1 can further comprise a sensor device 14 configured to determine the lateral and/or a horizontal position of the transmissive member 9, particularly relative to the membrane 7. The sensor device 14 can be particularly, configured to generate sensor information indicative of a position of the transmissive member 9. A respective sensor information can directly or indirectly indicate a position of the transmissive member 9 which corresponds to the respective zero-vertical position. The sensor device 14 can thus, be configured to determine if the transmissive member 9 is in the zero-vertical position and/or if the transmissive member 9 is not in the zero-vertical position. Alternatively or additionally, a respective sensor information can directly or indirectly indicate a position of the transmissive member 9 which corresponds to the operating position and/or to the non-operating position. The sensor device 14 can thus, be configured to determine if the transmissive member 9 is in the operating position and/or in the non-operating position or if the transmissive member 9 is not in operating position and/or not in the non-operating position, for instance.

A respective sensor device 14 can comprise one or more sensor elements 14.1 which can comprise at least one of: acoustic sensor elements, electro-mechanic sensor elements, magnetic sensor elements, electro-magnetic sensor elements, optic sensor elements, for instance. Respective sensor elements 14.1 can be provided with the frame structure of the adaptive suspension device 12 and/or adjacent to the frame structure of the adaptive suspension device 12, for instance.

Returning to the configuration of vat device 6, FIG. 8 shows an enlarged principle drawing of an exemplary configuration in which the vat device 6 comprises multiple frame-like vat device elements connectable or connected with each other to build the vat device 6. Respective frame-like vat device elements can form respective vat device elements 6.2, 6.3 mentioned above. Particularly, the vat device 6 comprises a first frame-like vat device element (see element 6.2) and a second frame-like vat device element (see element 6.3). The first frame-like vat device element can comprise at least one first connection interface 6.4 and the second frame-like vat device element can comprise at least one second connection interface 6.5, wherein the at least one first connection interface 6.4 and the at least one second connection interface 6.5 are configured to co-act to clamp the membrane 7 between the first frame-like vat device element and the second frame-like vat device element. In the exemplary embodiment, the first connection interface 6.4 and the second connection interface 6.5 are built as engagement elements. Particularly, the first connection interface 6.4, which is built as or comprises a receiving portion, is configured to receive the second connection element 6.5, which is a protrusion which engages the receiving portion. Further, bolted connections can be provided alternatively or additionally. As such, a highly stable attachment of the membrane 7 with the vat device 6 is possible which positively affects the quality of the manufacturing process and the three-dimensional objects 2 resulting therefrom.

FIG. 8 further shows that at least one of the first frame-like vat device element and the second frame-like vat device element can comprise or form a deformation compensation section 6.6 which is configured to compensate for deformation effects of the membrane 7 due to clamping the membrane between the at least one first frame-like vat device element and the second frame-like vat device element which could or would result in an uneven shape of the membrane 7 and consequently, in an uneven bottom of the receiving volume of the vat device 6. The generally plane base shape of the membrane 7 can thus, be assured at least when no forces are exerted to the membrane 7 resulting from motions of the build platform 8.1 towards the membrane 7. As such, the aforementioned zero-state of the membrane 7 can be implemented.

FIG. 8 shows that the deformation compensation section 6.5 of the first or second frame-like vat device element can comprise at least a first sub-section 6.6.1, a second sub-section 6.6.2 and a third sub-section 6.6.3. The at least three sub-sections 6.6.1-6.6.3 can form separate portions of a monolithic first or second frame-like vat device element. The second sub-section 6.6.2 can be arranged or formed between the first sub-section 6.6.1 and the third sub-section 6.6.3 and connecting same. The first sub-section 6.6.1 can extend inclined relative to the membrane 7, the third sub-section 6.6.3 can extend parallel to the membrane 7, and the second sub-section 6.6.2 can extend with a curvature. As such, a so-called Poisson compensation profile can be built.

FIG. 8 further shows that the membrane 7 can comprise multiple membrane elements 7.1, 7.2 connectable or connected with each other to build the membrane 7. The membrane elements 7.1, 7.2 forming the membrane 7 are typically, arranged in a vertically stacked arrangement, i.e. the membrane elements 7.1, 7.2 can be provided as stacked membrane layers. Forming the membrane 7 from multiple membrane elements 7.1, 7.2 or membrane layers can provide advantages e.g. with respect to a desired non-sticking behavior of the membrane 7 relative to different materials, such as a (cured) photocurable resin 3 and a material forming the transmissive member 9, for instance.

The multiple membrane elements 7.1, 7.2 or membrane layers can be bonded with each other by means of at least one bonding agent, e.g. an adhesive and/or cohesive bonding agent, for instance. Generally, bonding of at least two respective stacked membrane elements 7.1, 7.2 or membrane layers can be provided or supported by bonding agents, such as adhesive agents, for instance. Alternatively or additionally, mechanical bonding of the of at least two respective stacked membrane elements 7.1, 7.2 or membrane layers, e.g. via a force-and/or press-fit, is conceivable.

FIG. 8 particularly shows that the membrane 7 can comprise a first membrane element 7.1 or membrane layer which comprises an anti-sticking surface or an anti-sticking material which exhibits an anti-sticking effect relative to the photocurable resin 3, particularly relative to a resin layer 2.1 formed by curing the photocurable resin 3, and a second membrane element 7.2 or membrane layer which comprises an anti-sticking surface or an anti-sticking material which exhibits an anti-sticking effect relative to the transmissive member 9, particularly relative to the top surface 9.1 of the transmissive member 9. Respective anti-sticking effects enable that a resin layer 2.1 formed by (photo)curing the photocurable resin 3 can be easily removed from the membrane 7 and that the transmissive member 9 can be easily moved relative to the membrane 7, e.g. from the operating position into the non-operating position, even when there is a mechanical contact between the transmissive member 9 and the membrane 7 as is shown in FIG. 4. In other words, friction effects due a movement of the transmissive member 9 relative to the membrane 7 can be significantly reduced.

Hence, the first membrane element 7.1 or layer can generally be built of any anti-sticking or anti-friction material or material structure which reduces sticking or friction effects between the first membrane element 7.1 and a resin layer 2.1 formed by (photo) curing the photocurable resin 3. As an example, the first membrane element 7.1 or membrane layer can be made from or comprise at least one fluoropolymer, particularly (poly)tetrafluoroethylene or a (poly)tetrafluoroethylene compound, for instance. Likewise, the first membrane element 7.1 or membrane layer can be made from or comprise one or more (viscous) lubricant materials, such as or comprising silicone. Respective lubricant materials can comprise one or more anti-sticking or anti-friction materials.

Further, the second membrane element 7.2 or membrane layer can generally be built of any anti-sticking or anti-friction material or material structure which reduces sticking or friction effects between the second membrane element 7.2 or membrane layer and the transmissive member 9. As an example, the second membrane element 7.2 or membrane layer can be made from or comprise at least one polyester-based polymer, particularly poly(ethylene terephthalate) or a poly(ethylene terephthalate) compound. Likewise, the second membrane element 7.2 or membrane layer can be made from or comprise one or more (viscous) lubricant materials, such as or comprising silicone. Respective lubricant materials can comprise one or more anti-sticking or anti-friction materials.

In either case, the respective membrane element 7.1 which faces the build platform 8.1 can be used as the so-called zero-reference during the manufacturing process.

Additionally or alternatively, the transmissive member 9 could be provided, particularly at its top surface 9.1, with a respective anti-sticking surface or anti-sticking material which provides an anti-sticking effect relative to the membrane 7, particularly the lower surface of the membrane 7 which faces the transmissive member 9 in the operating position. Likewise, the transmissive member 9 can at least partly be coated with one or more (viscous) lubricant materials, such as or comprising silicone. Respective lubricant materials can comprise one or more anti-sticking or anti-friction materials.

FIG. 9 refers to an alternate embodiment of the apparatus 1 which differs from the embodiments shown in FIG. 1-7 in that the adaptive suspension device 12 is arranged to suspense the build platform 8.1. All annotations concerning the adaptive suspension of the transmissive member 9 via the adaptive suspension device 12 apply in analogous manner.

The apparatus 1 according to the exemplary embodiments of the Fig. enables implementing a method for additively manufacturing a three-dimensional object 2 by selectively and successively curing a photocurable resin 3 provided in a receiving volume 6.1 of a vat device 6 via electromagnetic radiation emitted from at least one irradiation device 5.

The method particularly comprises at least one step of: moving a transmissive member 9 in a horizontal motion plane MP in an operating position in which it provides a mechanical support for the membrane 7 of the vat device 6, and/or moving the transmissive member 9 in the or a horizontal motion plane MP in a non-operating position in which it does not provide a mechanical support for the membrane 7 of the vat device 6.

When implemented with an additive manufacturing apparatus 1 comprising a bottom-up configuration such as the one shown in FIG. 1-7 , the method can particularly, comprise the steps of: (i) moving a build platform 8.1 downward towards the membrane 7 of the vat device 6 thereby exerting a force F acting on the membrane 7 (as shown in FIG. 2) which results in a temporary deflection or deformation of the membrane 7 relative to a zero-state of the membrane 7 (as shown in FIG. 1); (ii) due to the deflection or deformation of the membrane 7, moving the transmissive member 9 positioned in an operating position below the membrane 7 in a downward direction thereby transferring one or more suspension elements 12.1 of an adaptive suspension device 12 which suspends the transmissive member 9 from their basic state (as shown in FIG. 1) in a compressed state (as shown in FIG. 2); (iii) transferring the one or more suspension elements 12.1 back to their basic state, thereby moving the transmissive member 9 upward in a zero-vertical position (as shown in FIG. 3); (iv′) optionally, detecting, e.g. via a sensor device 14, that the transmissive member 9 is in its zero-vertical position; (iv) emitting electromagnetic radiation from the irradiation device 5 to generate a cured resin layer 2.1, when the transmissive member 9 has been returned in its zero-vertical position and is arranged in its zero-vertical position (as shown in FIG. 4); (v) moving the transmissive member 9 in a non-operating position (as shown in FIG. 5), particularly so as to eliminate or reduce the suction effect between the cured resin layer 2.1 and the transmissive member 9 when moving the build platform 8.1 having the cured resin layer 2.1 attached thereto in an upward direction (because the transmissive member 9 is no longer below the cured resin layer 2.1 in the at least one non-operating position); (vi) moving the build platform 8.1 upward to create a space for new resin layer between the cured resin layer 2.1 and the membrane 7; and (vii) repeating the aforementioned steps (i)-(vi) one or more times until a three-dimensional object 2 of desired configuration is built.

The above steps (i)-(vii) can also be implemented with an additive manufacturing apparatus 1 having a top-down configuration in analogous manner.

The above-specified effect of compensating or at least reducing respective deflected or deformed portions of the membrane 7 can be improved by a respective upward motion of the transmissive member 9 towards the build platform 8.1. Particularly, the upward motion of the transmissive member 9 can increase the mechanical contact area between the transmissive member 9 and the membrane 7 resulting in an improved effect of compensating or at least reducing respective deflected or deformed portions of the membrane 7.

Aspects of the invention are also given by the following clauses whose subject-matter can be arbitrarily combined:
1. An additive manufacturing apparatus for additively manufacturing a three-dimensional object by curing a photocurable resin, particularly of a bottom-up configuration, comprising:
   a vat device, the vat device delimiting a receiving volume for receiving a photocurable resin, the bottom of the receiving volume being defined by a membrane, particularly an elastic membrane;
   a build platform device, the build platform device comprising a build platform, particularly arranged above the membrane, and moveably supported relative to the membrane in at least one degree of freedom of motion; and
   at least one irradiation device, particularly a digital light projector device, configured to emit electromagnetic radiation to selectively and successively cure the or a resin provided in the receiving volume to additively manufacture a three-dimensional object in a build direction.
2. The additive manufacturing apparatus of clause 1, further comprising a transmissive member arranged below the membrane, the transmissive member being moveably supported in a horizontal motion plane so as to be moveable in at least one operating position in which it is arranged below the membrane and in which it provides a mechanical support for the membrane, and in at least one non-operating position in which it is not arranged below the membrane and in which it does not provide a mechanical support for the membrane m
3. The additive manufacturing apparatus of clause 2 wherein, in a zero-state of the membrane, a gap space is present between the membrane and the transmissive member.
4. The additive manufacturing apparatus of any one of the preceding clauses, wherein the motion plane is a horizontal plane parallel to the base plane of the membrane or the build surface of the build platform, respectively.
5. The additive manufacturing apparatus of any one of the preceding clauses, wherein the at least one degree of freedom of motion of the transmissive member is a translatory motion of the transmissive member about a horizontal axis, particularly an axis parallel to the base plane of the membrane, and/or wherein the at least one degree of freedom of motion of the transmissive member is a rotational motion of the transmissive member about a vertical axis, particularly an axis perpendicular to the base plane of the membrane.
6. The additive manufacturing apparatus of any one of the preceding clauses, further comprising a actuator device coupleable or coupled with the transmissive member so as to exert a drive force on the transmissive member for moving the transmissive member from the at least one operating position into the at least one non-operating position, and vice versa.
7. The additive manufacturing apparatus of any one of the preceding clauses, further comprising a controller configured to control motion of the transmissive member between the operating position and the non-operating position, and vice versa.
8. The additive manufacturing apparatus of any one of the preceding clauses, wherein, in the at least one operating position, the transmissive member compensates for a deformation, particularly a curvature, of the membrane resulting from a motion, particularly a downward motion, of the building platform towards the membrane.
9. The additive manufacturing apparatus of any one of the preceding clauses, further comprising an adaptive suspension device, the adaptive suspension device configured to suspense the transmissive member.
10. The additive manufacturing apparatus of clause 8, wherein the adaptive suspension device comprises one or more suspension elements, the one or more suspension elements being adjustable with respect to a suspension direction of the suspension device, particularly corresponding to the build direction.
11. The additive manufacturing apparatus of clause 9, wherein the at least one suspension element is built as or comprises a spring element, particularly a compression spring element.
12. The additive manufacturing apparatus of any one of clauses 9-11, wherein the adaptive suspension device is moveably supported relative to the membrane in at least one degree of freedom of motion in the or a horizontal motion plane so as to be moveable in at least one first position in which the transmissive member suspended by the adaptive suspension device is in its operating position and in at least one second position in which the transmissive member suspended by the adaptive suspension device is in its non-operating position.
13. The additive manufacturing apparatus of any one of the preceding clauses, further comprising at least one sensor device, the sensor device comprising one or more sensor elements configured to determine the lateral and/or a horizontal position of the transmissive member, particularly relative to the membrane.
14. The additive manufacturing apparatus of clause 13, wherein the at least one sensor device is configured to generate sensor information indicative of a position of the transmissive member which corresponds to its operating position.
15. The additive manufacturing apparatus of any one of clauses 14, wherein the one or more sensor elements are built as or comprise electrical, optical, electro-optical, magnetic, or electro-magnetic sensor elements.
16. The additive manufacturing apparatus of any one of the preceding clauses, wherein the transmissive member is built as or comprises a glass plate, particularly a borosilicate glass plate.
17. The additive manufacturing apparatus of any one of the preceding clauses, wherein the vat device comprises multiple frame-like vat device elements connectable or connected with each other to build the vat device.
18. The additive manufacturing apparatus of clause 17, wherein the vat device comprises a first frame-like vat device element and a second frame-like vat device element, wherein the first frame-like vat device element comprises at least one first connection interface and the second frame-like vat device element comprises at least one second connection interface, wherein the at least one first connection interface and the at least one second connection interface are configured to co-act to clamp the membrane between the first frame-like vat device element and the second frame-like vat device element.
19. The additive manufacturing apparatus of clause 18 or 19, wherein at least one of the first frame-like vat device element and the second frame-like vat device element comprises a deformation compensation section which compensates for deformation effects of the membrane which would result in an uneven bottom of the receiving volume at least in one operational state of the membrane.
20. The additive manufacturing apparatus of clause 19, wherein the deformation compensation section comprises at least a first, second and third, sub-section, wherein the first sub-section extends inclined relative to the membrane, the third sub-section extends parallel to the membrane, and the second sub-section being arranged between the first and the third sub-section and connecting same extends with a curvature.
21. The additive manufacturing apparatus of any one of the preceding clauses, wherein the membrane comprises multiple membrane elements connectable or connected with each other in a vertically stacked arrangement to build the membrane.
22. The additive manufacturing apparatus of clause 20, wherein the membrane comprises a first membrane element which comprises an anti-sticking surface or anti-sticking material which enables an anti-sticking effect relative to the or a resin provided in the receiving volume, and a second membrane element which comprises an anti-sticking surface or anti-sticking material which enables an anti-sticking effect relative to the transmissive member.
23. The additive manufacturing apparatus of clause 22, wherein the first membrane element is built of or comprises at least one fluoropolymer, particularly tetrafluoroethylene or a tetrafluoroethylene compound, and/or wherein the second membrane element is built of or comprises at least one polyester-based polymer, particularly poly(ethylene terephthalate) or a poly(ethylene terephthalate) compound.
24. The additive manufacturing apparatus of any one of clauses 21-23, wherein the multiple membrane elements are bonded with each other by means of an adhesive and/or cohesive bonding agent.
25. A method for additively manufacturing a three-dimensional object by selectively and successively curing a resin provided in a receiving volume of a vat device via electromagnetic radiation emitted from at least one irradiation device of an additive manufacturing apparatus, particularly an additive manufacturing apparatus according to any one of the preceding clauses, the method comprising at least the step of:
moving a transmissive member in a horizontal motion plane in at least one operating position in which it is arranged below a membrane and in which it provides a mechanical support for the membrane of the vat device of an additive manufacturing apparatus, and/or moving the or a transmissive member in the or a horizontal motion plane in at least one non-operating position in which it is not arranged below the or a membrane of the additive manufacturing apparatus and in which it does not provide a mechanical support for the membrane of the vat device of the additive manufacturing apparatus.
26. The method of clause 25, further comprising at least one of the steps of:
(i) moving a build platform downward towards the membrane of the vat device of the additive manufacturing apparatus thereby exerting a force acting on the membrane which results in a geometric deformation of the membrane, particularly a curvature of the membrane, towards the surface of the transmissive member being disposed below the membrane;
(ii) due to the deformation of the membrane moving the transmissive member in a downward direction thereby transferring one or more suspension elements of an adaptive suspension device which suspends the transmissive member from their original state in a compressed state;
(iii) transferring the one or more suspension elements back to their original state, thereby moving the transmissive member upward in its operating position in which it is arranged below the membrane and in which it provides a mechanical support for the membrane of the vat device of the additive manufacturing apparatus;
(iv) emitting radiation from the irradiation device to generate a cured resin layer;
(v) moving the transmissive member in its at least one non-operating position, thereby reducing or eliminating the suction effect between the cured resin layer and the transmissive member;
(vi) moving the build platform upward to create a space between the cured resin layer and the membrane for new resin layer;
(vii) repeating the aforementioned steps (i)-(vi) one or more times.

What is claimed is:

1. An additive manufacturing apparatus for additively manufacturing a three-dimensional object by curing a photocurable resin, particularly of a bottom-up configuration, comprising:
a vat device, the vat device delimiting a receiving volume for receiving a photocurable resin, the bottom of the receiving volume being defined by a membrane, particularly an elastic membrane;
a build platform device, the build platform device comprising a build platform, particularly arranged above the membrane, moveably supported relative to the membrane in at least one degree of freedom of motion;
a transmissive member arranged below the membrane, the transmissive member being moveably supported in a horizontal motion plane so as to be moveable in at least one operating position in which it is arranged below the membrane and in which it provides a mechanical support for the membrane, particularly for a deformed membrane, and in at least one non-operating position in which it is not arranged below the membrane and in which it does not provide a mechanical support for the membrane; and
at least one irradiation device, particularly a digital light projector device, disposed below the transmissive member, the at least one irradiation device configured to emit electromagnetic radiation to selectively and successively cure the or a resin provided in the receiving volume to additively manufacture a three-dimensional object in a build direction.

2. The additive manufacturing apparatus of claim 1, wherein, in a zero-state of the membrane, a gap space is present between the membrane and the transmissive member.

3. The additive manufacturing apparatus of claim 1, wherein the motion plane is a horizontal plane parallel to the base plane of the membrane or the build surface of the build platform, respectively.

4. The additive manufacturing apparatus of claim 1, wherein the at least one degree of freedom of motion of the transmissive member is a translatory motion of the transmissive member about a horizontal axis, particularly an axis parallel to the base plane of the membrane, and/or wherein the at least one degree of freedom of motion of the transmissive member is a rotational motion of the transmissive member about a vertical axis, particularly an axis perpendicular to the base plane of the membrane.

5. The additive manufacturing apparatus of claim 1, further comprising an actuator device coupleable or coupled with the transmissive member so as to exert a drive force on the transmissive member for moving the transmissive member from the at least one operating position into the at least one non-operating position, and vice versa.

6. The additive manufacturing apparatus of claim 1, further comprising a controller configured to control motion of the transmissive member between the operating position and the non-operating position, and vice versa.

7. The additive manufacturing apparatus of claim 1, wherein, in the at least one operating position, the transmissive member compensates for a deformation, particularly a curvature, of the membrane resulting from a motion, particularly a downward motion, of the building platform towards the membrane.

8. The additive manufacturing apparatus of claim 1, further comprising an adaptive suspension device, the adaptive suspension device configured to suspense the transmissive member.

9. The additive manufacturing apparatus of claim 8, wherein the adaptive suspension device comprises one or more suspension elements, the one or more suspension elements being adjustable with respect to a suspension direction of the suspension device, particularly corresponding to the build direction.

10. The additive manufacturing apparatus of claim 9, wherein the at least one suspension element is built as or comprises a spring element, particularly a compression spring element.

11. The additive manufacturing apparatus of claim 8, wherein the adaptive suspension device is moveably supported relative to the membrane in at least one degree of freedom of motion in the or a horizontal motion plane so as to be moveable in at least one first position in which the transmissive member suspended by the adaptive suspension device is in its operating position and in at least one second position in which the transmissive member suspended by the adaptive suspension device is in its non-operating position.

12. The additive manufacturing apparatus of claim 1, further comprising at least one sensor device, the sensor device comprising one or more sensor elements configured to determine the lateral and/or a horizontal position of the transmissive member, particularly relative to the membrane, wherein the at least one sensor device is configured to generate sensor information indicative of a position of the transmissive member which corresponds to its operating position.

13-14. (canceled)

15. The additive manufacturing apparatus of claim 1, wherein the transmissive member is built as or comprises a glass plate, particularly a borosilicate glass plate.

16. The additive manufacturing apparatus of claim 1, wherein the vat device comprises multiple frame-like vat device elements connectable or connected with each other to build the vat device, wherein the vat device comprises a first frame-like vat device element and a second frame-like vat device element, wherein the first frame-like vat device element comprises at least one first connection interface and the second frame-like vat device element comprises at least one second connection interface, wherein the at least one first connection interface and the at least one second connection interface are configured to co-act to clamp the membrane between the first frame-like vat device element and the second frame-like vat device element.

17. (canceled)

18. The additive manufacturing apparatus of claim 16, wherein at least one of the first frame-like vat device element and the second frame-like vat device element comprises a deformation compensation section which compensates for deformation effects of the membrane which would result in an uneven bottom of the receiving volume at least in one operational state of the membrane.

19. The additive manufacturing apparatus of claim 18, wherein the deformation compensation section comprises at least a first, second and third, sub-section, wherein the first sub-section extends inclined relative to the membrane, the third sub-section extends parallel to the membrane, and the second sub-section being arranged between the first and the third sub-section and connecting same extends with a curvature.

20. The additive manufacturing apparatus of claim 1, wherein the membrane comprises multiple membrane elements connectable or connected with each other in a vertically stacked arrangement to build the membrane, wherein the membrane comprises a first membrane element which comprises an anti-sticking surface or anti-sticking material which enables an anti-sticking effect relative to the or a resin provided in the receiving volume, and a second membrane element which comprises an anti-sticking surface or anti-sticking material which enables an anti-sticking effect relative to the transmissive member.

21. (canceled)

22. The additive manufacturing apparatus of claim 20, wherein the first membrane element is built of or comprises at least one fluoropolymer, particularly tetrafluoroethylene or a tetrafluoroethylene compound, and/or wherein the second membrane element is built of or comprises at least one polyester-based polymer, particularly poly(ethylene terephthalate) or a poly(ethylene terephthalate) compound.

23. The additive manufacturing apparatus of claim 17, wherein the multiple membrane elements are bonded with each other by means of an adhesive and/or cohesive bonding agent.

24. A method for additively manufacturing a three-dimensional object by selectively and successively curing a resin provided in a receiving volume of a vat device via electromagnetic radiation emitted from at least one irradiation device of an additive manufacturing apparatus, particularly an additive manufacturing apparatus according to claim 1, the method comprising at least the step of:
moving a transmissive member in a horizontal motion plane in at least one operating position in which it is arranged below a membrane and in which it provides a mechanical support for the membrane of the vat device of an additive manufacturing apparatus, and/or moving the or a transmissive member in the or a horizontal motion plane in at least one non-operating position in which it is not arranged below the or a membrane of the additive manufacturing apparatus and in which it does not provide a mechanical support for the membrane of the vat device of the additive manufacturing apparatus.

25. (canceled)
